(19) United States
(12) Patent Application Publication
(10) Pub. No.: US 2020/0083566 A1
(43) Pub. Date: Mar. 12, 2020

(54) SOLID-LIKE MAGNESIUM-ION CONDUCTOR INCLUDING POROUS SILICA AND ELECTROLYTE, AND SECONDARY BATTERY USING THE SAME

(71) Applicant: Panasonic Intellectual Property Management Co., Ltd., Osaka (JP)

(72) Inventor: HIROKI YABE, Osaka (JP)

(21) Appl. No.: 16/503,475

(22) Filed: Jul. 4, 2019

(30) Foreign Application Priority Data
Sep. 6, 2018 (JP) 2018-166520

(51) Int. Cl. H01M 10/0569; H01M 10/054

(52) U.S. Cl. CPC H01M 10/0569; H01M 2300/0085; H01M 2300/0028; H01M 10/054

(57) ABSTRACT

A solid-like magnesium-ion conductor includes an electrolyte and a porous silica. The electrolyte is filled in a plurality of pores of the porous silica. The electrolyte includes a magnesium salt, and an ionic liquid that contains the 1-ethyl-3-methylimidazolium ion.

### BACKGROUND

### 1. Technical Field

The present disclosure relates to a solid-like magnesium-ion conductor and a secondary battery using it.

### 2. Description of the Related Art

In recent years, it has been hoped that secondary batteries that conduct a multivalent ion would be put into practical use. In particular, magnesium secondary batteries have a higher theoretical capacity than the known, lithium-ion batteries.

Japanese Unexamined Patent Application Publication No. 2016-162543 discloses a magnesium battery that uses a polymer gel electrolyte including a magnesium-salt-containing electrolyte solution and a rotaxane network polymer.

### SUMMARY

In one general aspect, the techniques disclosed here feature a solid-like magnesium-ion conductor. The conductor includes an electrolyte and porous silica. The porous silica has multiple pores, in which the electrolyte is filled. The electrolyte includes a magnesium salt, and an ionic liquid that contains the 1-ethyl-3-methylimidazolium ion (or EMI⁺).

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-section schematically illustrating an exemplary construction of a solid-like magnesium-ion conductor according to an embodiment;

FIG. 2 is a cross-section schematically illustrating an exemplary construction of a secondary battery according to an embodiment;

FIG. 3 illustrates the molar ratio of Mg(OTf)₂ to EMI-TFSI versus total ionic conductivity, the transport number of magnesium ions, or magnesium ion conductivity for samples 1 and 14 to 22;

FIG. 4 illustrates a cyclic voltammogram of a battery cell in the Example; and

FIG. 5 illustrates XANES spectra from a battery cell in the Example.

### DETAILED DESCRIPTION

The following describes a solid-like magnesium-ion conductor according to an embodiment in detail using drawings.

The following description is entirely about general or specific examples. Information such as numerical values, compositions, shapes, thicknesses, electrical properties, structures of secondary batteries, and electrode materials are illustrative and not intended to limit any aspect of the disclosure, and those elements that are not recited in an independent claim, which defines the most generic concept, are optional.

The following chiefly describes a solid-like magnesium-ion conductor and a secondary battery using it, but solid-like magnesium-ion conductors according to an aspect of the present disclosure are not limited to these applications. For example, the solid-like magnesium-ion conductors may be used in electrochemical devices, such as ion concentration sensors.

### 1. Solid-Like Magnesium-Ion Conductor

A solid-like magnesium-ion conductor according to an embodiment includes porous silica, which has multiple pores, and an electrolyte that fills the pores. This magnesium-ion conductor maintains a solid-like state and conducts magnesium ions.

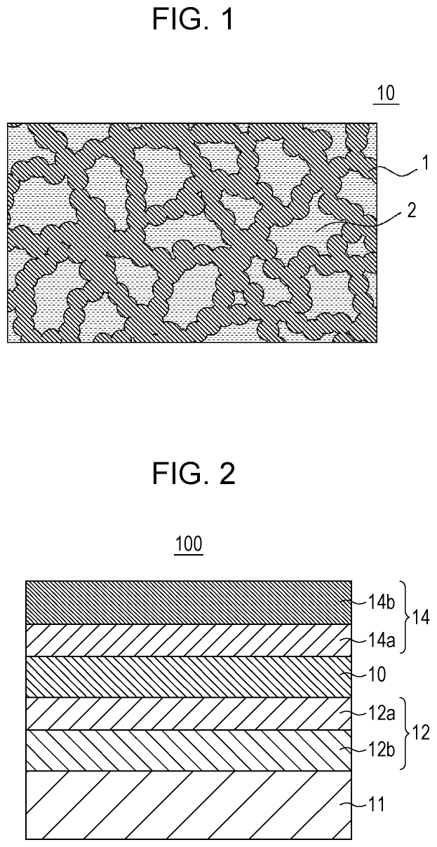

FIG. 1 is a cross-section schematically illustrating an exemplary construction of a solid-like magnesium-ion conductor 10. As illustrated in FIG. 1, the magnesium-ion conductor 10 includes porous silica 1 and an electrolyte 2. The porous silica 1 has multiple pores, and their inside is filled with the electrolyte 2. The electrolyte 2 may fill the pores completely or partially.

### 2. Porous Silica

The porous silica 1 is formed by silicon dioxide and has multiple pores. Silica is superior, for example to organic polymers, in heat resistance, mechanical strength, and resistance to chemicals, such as organic solvents.

The porous silica 1 may have, for example, a network structure formed by multiple silica particles or multiple silica fibers joined together. This can increase the specific surface area of the porous silica 1 and thereby can increase the area of contact between the porous silica 1 and electrolyte 2. An increased area of contact allows the porous silica 1 to hold the electrolyte 2 in its pores stably.

The average size (diameter) of the pores is, for example, between 2 and 100 nm. This allows the porous silica 1 to hold the electrolyte 2 stably. The average size (diameter) of the pores may be between 2 and 50 nm. In this case, the porous silica 1 is mesoporous silica, which has multiple mesopores.

The pores are, for example, connected together. The connected pores may form paths through which the electrolyte 2 can flow, and the magnesium ions in the electrolyte 2 may move through these paths.

Silica particles have an average diameter of, for example, 1 to 100 nm. The average diameter of the silica particles may be 10 nm or less. This increases the area of contact between the porous silica 1 and electrolyte 2. The average diameter of the silica particles may be 2 nm or more. This can make the porous silica 1 strong enough.

The following is an example of how to measure the average diameter of the silica particles. First, the porous silica 1 is isolated by extracting the electrolyte 2 from the magnesium-ion conductor 10 using a solvent, such as acetone or ethanol. Then the porous silica 1 is observed under a scanning electron microscope (SEM) or transmission electron microscope (TEM), and thereby its microscopic structure is imaged. Lastly, ten to twenty silica particles are selected randomly from those in the SEM or TEM image, the equivalent circular diameter, or the diameter of a circle having the same area as the projected area of the particle, is calculated for each of the selected silica particles, and the calculated diameters are averaged.

Silica fibers have an average cross-sectional diameter of, for example, 1 to 100 nm. The average cross-sectional diameter of the silica fibers may be 10 nm or less. This increases the area of contact between the porous silica 1 and electrolyte 2. The average cross-sectional diameter of the silica fibers may be 2 nm or more. This can make the porous silica 1 strong enough.

An example of how to calculate the average cross-sectional diameter of the silica fibers is the same as that for the average diameter of silica particles, described above.

The porous silica 1 may have functional groups on its surface. The functional groups can be, for example, amino, hydroxyl, carboxyl, or siloxane groups.

The surface of the porous silica 1 has, for example, a slight positive charge. The positive charge attracts the charge of anions in the electrolyte 2, thereby weakening the constraint of magnesium ions to these anions.

### 3. Electrolyte

The electrolyte 2 includes a magnesium salt and an ionic liquid. The electrolyte 2 conducts magnesium ions.

### 3-1. Magnesium Salt

The magnesium salt may be an inorganic magnesium salt or may be an organic magnesium salt.

Examples of inorganic magnesium salts include MgCl₂, MgBr₂, MgI₂, Mg(PF₆)₂, Mg(BF₄)₂, Mg(ClO₄)₂, Mg(AsF₆)₂, MgSiF₆, Mg(SbF₆)₂, Mg(AlO₄)₂, Mg(AlCl₄)₂, and Mg(B₁₂FₐH₁₂₋ₐ)₂ (where a is an integer of 0 to 3).

Examples of organic magnesium salts include Mg[N(SO₂CₘF₂ₘ₊₁)₂]₂ (where m is an integer of 1 to 8), Mg[PFₙ(CₚF₂ₚ₊₁)₆₋ₙ]₂ (where n is an integer of 1 to 5, and p is an integer of 1 to 8), Mg[BF_{q}(CₛF₂ₛ₊₁)_{4-q}]₂ (where q is an integer of 1 to 3, and s is an integer of 1 to 8), Mg[B(C₂O₄)₂]₂, Mg[BF₂(C₂O₄)]₂, Mg[B(C₃O₄H₂)₂]₂, Mg[PF₄(C₂O₂)]₂, magnesium benzoate, magnesium salicylate, magnesium phthalate, magnesium acetate, magnesium propionate, and Grignard reagents. Examples of imide salts Mg[N(SO₂CₘF₂ₘ₊₁)₂]₂ include Mg[CF₃SO₃]₂ (or Mg(OTf)₂), Mg[N(CF₃SO₂)₂]₂ (or Mg(TFSI)₂), Mg[N(SO₂CF₃)₂]₂, and Mg[N(SO₂C₂F₅)₂]₂. An example of a fluorinated alkylfluorophosphate Mg[PFₙ(CₚF₂ₚ₊₁)₆₋ₙ]₂ is Mg(PF₅(CF₃))₂. An example of a fluorinated alkylfluoroborate Mg[BF_{q}(CₛF₂ₛ₊₁)_{4-q}]₂ is Mg[BF₃(CF₃)]₂.

The magnesium salt may be, for example, magnesium trifluoromethanesulfonate (or Mg(OTf)₂), magnesium bis(trifluoromethanesulfonyl)imide (or Mg(TFSI)₂), magnesium tetrafluoroborate (or Mg(BF₄)₂), or magnesium perchlorate (or Mg(ClO₄)₂). These salts, when combined with the 1-ethyl-3-methylimidazolium ion (or EMI⁺) and silica, are highly soluble in the ionic liquid and easily dissociate into their constituting magnesium ion and anion in the ionic liquid. Moreover, these salts do not cause a great increase in viscosity when mixed with the ionic liquid.

### 3-2. Ionic Liquid

The ionic liquid is a molten salt whose melting point is, for example, between −95° C. and 400° C.

The ionic liquid contains the 1-ethyl-3-methylimidazolium ion (EMI⁺) as a cation.

This improves the magnesium ion conductivity of the electrolyte 2. The reason is unclear, but presumably is as follows. In the electrolyte 2, magnesium ions are present as molecular assemblies as a result of coordination by molecules of the ionic liquid. EMI⁺, small in size, easily coordinates around the magnesium ions, and the resulting molecular assemblies can also be small in size. As a consequence, the molecular assemblies can travel inside the electrolyte 2 easily, hence the improved magnesium ion conductivity.

The ionic liquid contains, for example, a halide ion, fluoride complex ion, carboxylate ion, sulfonate ion, imide ion, cyanide ion, organic phosphate ion, chloroaluminate ion, perchlorate ion (or ClO₄⁻), or nitrate ion (or NO₃⁻) as an anion.

Examples of halide ions include Cl⁻, Br⁻, and I⁻.

Examples of fluoride complex ions include BF₄⁻, PF₆⁻, AsF₆⁻, SbF₆⁻, NbF₆⁻, and TaF₆⁻.

Examples of carboxylate ions include CH₃COO⁻, CF₃COO⁻, and C₃F₇COO⁻.

Examples of sulfonate ions include CH₃SO₃⁻, CF₃SO₃⁻, C₂F₅SO₃⁻, C₃F₇SO₃⁻, C₄F₉SO₃⁻, CH₃OSO₃⁻, C₂H₅OSO₃⁻, C₄H₉OSO₃⁻, n-C₆H₁₃OSO₃⁻, n-C₈H₁₇OSO₃⁻, CH₃(OC₂H₄)₂OSO₃⁻, and CH₃C₆H₄SO₃⁻.

Examples of imide ions include (FSO₂)₂N⁻, (CF₃SO₂)₂N⁻ (or TFSI⁻), (CF₃SO₂)(CF₃CO)N⁻, (C₂F₅SO₂)₂N⁻, (C₃F₇SO₂)₂N⁻, and (C₄F₉SO₂)₂N⁻. It should be noted that the term “imide” herein refers to what is called an “amide” in the nomenclature of the International Union of Pure and Applied Chemistry (IUPAC) and therefore can be read as “amide” if necessary.

Examples of cyanide ions include SCN⁻, (CN)₂N⁻ (or DCA⁻), and (CN)₃C⁻.

Examples of organic phosphate ions include (CH₃O)₂PO₂⁻, (C₂H₅O)₂PO₂⁻, and (C₂F₅)₃PF₃⁻.

Examples of chloroaluminate ions include AlCl₄⁻ and Al₂Cl₇⁻.

Examples of other anions include F(HF)ₙ⁻, OH⁻, and (CF₃SO₂)₃C⁻.

The ionic liquid may contain, for example, at least one selected from the group consisting of the dicyanamide ion (or DCA⁻), tetrafluoroborate ion (or BF₄⁻), and bis(trifluoromethanesulfonyl)imide ion (or TFSI⁻) as anion(s).

The molecular weight of the ionic liquid may be, for example, 400 or less. This can facilitate the conduction of magnesium ions by limiting the size of the molecular assemblies formed by magnesium ions and their ligands. Examples of ionic liquids having a molecular weight of 400 or less include 1-ethyl-3-methylimidazolium dicyanamide (or EMI-DCA), 1-ethyl-3-methylimidazolium tetrafluoroborate (or EMI-BF₄), and 1-ethyl-3-methylimidazolium bis(trifluoromethanesulfonyl)imide (or EMI-TFSI).

The molecular weight of the ionic liquid can be measured using, for example, capillary electrophoresis-mass spectrometry (CE-MS). In CE-MS, a compound is electrically charged to separate into its anion and cation, and each of the anion and cation is analyzed by mass spectrometry.

The anion in the ionic liquid may satisfy one of 4×n≤L≤5×n and 5/n≤L≤4/n, where L is the anion's size (Å), and n is a positive integer. Since Si—O bond distances on the surface of silica are between 4 and 5 Å, an anion whose size falls within any of the above ranges tends to be dense and aligned on the inner surface of the pores of the porous silica 1. Dense alignment weakens the constraint of magnesium ions to the anion in the electrolyte 2. Examples of such anions include the dicyanamide ion (or DCA⁻) and the tetrafluoroborate ion (or BF₄⁻). DCA⁻ has a size of 4.5 Å, which means DCA⁻ can adsorb with one ion per Si—O bond. BF₄⁻ has a size of 2.3 Å, which means BF₄⁻ can adsorb with two ions per Si—O bond.

The integer n may be, for example, between 1 and 3. This helps the anion become aligned on the surface of the silica because in such a case, it is easier for electrical charge to be balanced locally between the anion and the surface of the silica.

The size L of the anion is determined by the kind of anion. To find the size of an anion, van der Waals spheres are first assumed for the pair of constituting atoms that are farther apart than any other pair. The maximum distance between the surface of one sphere and that of the other is defined as the size of the anion.

### 3-3. Molar Ratio of the Magnesium Salt to the Ionic Liquid

The molar ratio of the magnesium salt to the ionic liquid in the electrolyte 2 is not critical. For example, it may be more than 0.03 and less than 0.17 or may even be more than 0.04 and less than 0.10. This helps ensure a sufficient quantity of magnesium ions are available in the electrolyte 2 with little increase in viscosity caused by interactions between the magnesium ions and the anion in the ionic liquid. As a result, ionic conductivity is improved.

An example of how to check the molar ratio of the magnesium salt to the ionic liquid is through the use of the CE-MS technique described above.

This improvement in ionic conductivity, which may possibly vary in degree with the kind(s) of anion(s) contained in the electrolyte 2 though, appears to take place as long as the electrolyte 2 contains the EMI⁺ and magnesium ions as major cations. The first possible reason is that the electrostatic effects involving the cations do not change. The second is that the coordination number and state of coordination of the anion in the ionic liquid around the magnesium ions greatly depend on the size of the EMI⁺ ion and the molar ratio between the EMI⁺ and magnesium ions. That is, electrolytes 2 that contain these cations in a molar ratio falling within the ranges specified above can exhibit similar coordination numbers and similar states of coordination.

### 4. Molar Ratio of the Ionic Liquid to the Porous Silica

The molar ratio of the ionic liquid to the porous silica 1 is not critical. For example, it may be more than 1.0. In other words, the number of moles of the ionic liquid may be larger than that of the porous silica 1. This makes the magnesium-ion conductor 10 sufficiently conductive to magnesium ions. The molar ratio of the ionic liquid to the porous silica 1 may even be 1.5 or more.

The molar ratio of the ionic liquid to the porous silica 1 may be 5.0 or less. This helps the magnesium-ion conductor 10 maintain its solid-like state stably.

The following is an example of how to check the molar ratio of the ionic liquid to the porous silica 1. First, the porous silica 1 is isolated by extracting the electrolyte 2 from the magnesium-ion conductor 10 using a solvent, such as acetone or ethanol. Then the quantity of ionic liquid in the extracted electrolyte 2 is determined by CE-MS. The isolated porous silica 1 is dried and weighed, and the measured mass is converted into the number of moles. If the porous silica 1 has organic functional groups on its surface, these organic functional groups may be removed, for example by firing at temperatures of approximately 500° C.

### 5. Production of the Magnesium-Ion Conductor

A magnesium-ion conductor 10 according to this embodiment can be produced by, for example, a sol-gel process. In an exemplary configuration, this sol-gel process may include mixing water, a compatibilizer, an alkoxysilane, an EMI⁺-containing ionic liquid, and a magnesium salt; forming a wet gel through polycondensation of the alkoxysilane; and drying the wet gel.

The compatibilizer can be, for example, an alcohol, an ether, or a ketone. Examples of alcohols include methanol, ethanol, propanol, butanol, and 1-methoxy-2-propanol (or PGME). Examples of ethers include diethyl ether, dibutyl ether, tetrahydrofuran, and dioxane. Examples of ketones include methyl ethyl ketone, and methyl isobutyl ketone.

The alkoxysilane is, for example, a tetraalkoxysilane. Examples of tetraalkoxysilanes include tetraethoxysilane (or TEOS) and tetramethoxysilane.

In the formation of a wet gel, the liquid mixture may be, for example, left at room temperature for days to about 2 weeks.

In the drying of the wet gel, the wet gel may be left in a vacuum or may be heated. The duration of vacuum drying may be, for example, between 1 and 10 days. The heating temperature may be, for example, between 35° C. and 150° C. Drying the wet gel will remove water and the compatibilizer therefrom and give a magnesium-ion conductor 10.

As known, it is typically more difficult to produce an ion conductor as a solid gel from a liquid mixture that contains magnesium ions than from a liquid mixture that contains lithium ions. The first possible reason is that divalent magnesium ions tend to interfere with the gelation of a liquid mixture containing them because they interact with their surrounding anions strongly in comparison with monovalent lithium ions. The second is that increasing the alkoxysilane content will help the liquid mixture to gel, but too much alkoxysilane will cause ionic conductivity to be lost. The third is that adding an acid as a catalyst to the liquid mixture will promote gelation, but in this case, protons produced by the acid interfere with the conduction of magnesium ions.

The production method described above, by contrast, promotes the gelation of the magnesium-ion conductor, presumably by virtue of the following actions. The EMI⁺ in the ionic liquid is relatively small ions and therefore can interact with many surrounding anions. The presence of EMI⁺ therefore weakens the interactions between magnesium ions and anions, thereby promoting the gelation of the liquid mixture. The magnesium salt, moreover, functions as an acid catalyst; it promotes gelation without producing unnecessary protons. Owing to these actions, in this method, a highly conductive solid-like magnesium-ion conductor 10 can be formed without requiring too much alkoxysilane.

### 6. Secondary Battery

### 6-1. Structure

FIG. 2 is a cross-section schematically illustrating an exemplary construction of a secondary battery 100 according to an embodiment.

The secondary battery 100 includes a substrate 11, a cathode 12, a magnesium-ion conductor 10, and an anode 14. The magnesium-ion conductor 10 is between the cathode 12 and anode 14. Magnesium ions can move between the cathode 12 and anode 14 through the magnesium-ion conductor 10.

The structure of the secondary battery 100 may be, for example, cylindrical, square, button-shaped, coin-shaped, or flat-plate.

In an exemplary configuration, the secondary battery 100 is contained in a battery casing. The shape of the secondary battery 100 and/or battery casing may be, for example, rectangular, round, oval, or hexagonal.

### 6-2. Substrate

The substrate 11 may be an insulating substrate or may be an electrically conductive substrate. Examples of substrates 11 include a glass substrate, a plastic substrate, a polymer film, a silicon substrate, a metal plate, a metal foil sheet, and a stack thereof. The substrate 11 may be a commercially available one or may be produced by a known method.

In the secondary battery 100, the substrate 11 is optional.

### 6-3. Cathode

The cathode 12 includes, for example, a cathode mixture layer 12a, which contains a cathode active material, and a cathode collector 12b.

The cathode mixture layer 12a contains a cathode active material capable of occluding and releasing magnesium ions.

The cathode active material can be, for example, a metal oxide, a polyanion salt compound, a sulfide, a chalcogenide compound, or a hydride. Examples of metal oxides include transition metal oxides, such as V₂O₅, MnO₂, and MoO₃, and magnesium composite oxides, such as MgCoO₂ and MgNiO₂. Examples of polyanion salt compounds include MgCoSiO₄, MgMnSiO₄, MgFeSiO₄, MgNiSiO₄, MgCo₂O₄, and MgMn₂O₄. An example of a sulfide is Mo₆S₈. An example of a chalcogenide compound is Mo₉Se₁₁.

In an exemplary configuration, the cathode active material is a crystalline substance. The cathode mixture layer 12a may contain two or more cathode active materials.

If necessary, the cathode mixture layer 12a may further contain an electrically conducting material and/or a binder.

The conducting material only needs to be a material that conducts electrons, so that any such material can be used. For example, the conducting material can be a carbon material, a metal, or an electrically conductive polymer. Examples of carbon materials include graphite, such as natural graphite (e.g., vein and flake graphite) and artificial graphite, acetylene black, carbon black, Ketjenblack, carbon whiskers, needle coke, and carbon fiber. Examples of metals include copper, nickel, aluminum, silver, and gold. One of these materials may be used alone, or two or more may be used as a mixture. In an exemplary configuration, the conducting material may be carbon black or acetylene black to provide electronic conductivity and the ease of coating.

As for the binder, its only essential role is to bind particles of the active material and conducting material, and any material capable of it can be used. Examples of binders include fluoropolymers, such as polytetrafluoroethylene, polyvinylidene fluoride, and fluororubbers, thermoplastic resins, such as polypropylene and polyethylene, ethylene propylene diene monomer rubber, sulfonated ethylene propylene diene monomer rubber, and natural butyl rubber. One of these materials may be used alone, or two or more may be used as a mixture. In an exemplary configuration, the binder may be an aqueous dispersion of a cellulose material or styrene butadiene rubber.

The solvent for dispersing the cathode active material, electrically conducting material, and binder can be, for example, N-methylpyrrolidone, dimethylformamide, dimethylacetamide, methyl ethyl ketone, cyclohexanone, methyl acetate, methyl acrylate, diethylenetriamine, N,N-dimethylaminopropylamine, ethylene oxide, or tetrahydrofuran. In an exemplary configuration, a thickening agent may be added to the dispersant. The thickening agent can be, for example, carboxymethyl cellulose or methyl cellulose.

The following is an example of how to form the cathode mixture layer 12a. First, a cathode active material, a conducting material, and a binder are mixed. The resulting mixture is combined with an appropriate solvent to give a cathode mixture in paste form. This cathode mixture is then applied to the surface of a cathode collector 12b and dried, forming a cathode mixture layer 12a on the cathode collector 12b. The cathode mixture may be compressed to increase the electrode density.

The thickness of the cathode mixture layer 12a is not critical. In an exemplary configuration, it is 1 μm or more and 100 μm or less.

Alternatively, the cathode 12 may have a cathode active material layer, a layer exclusively of a cathode active material, instead of the cathode mixture layer 12a. In this case, the layer 12a in FIG. 2 corresponds to the cathode active material layer.

The cathode collector 12b is formed by an electron conductor that is chemically inert toward the cathode mixture layer 12a within the range of operating voltages of the secondary battery 100. The operating voltage of the cathode collector 12b may be in the range of, for example, +1.5 V to +4.5 V with respect to the standard redox potential of magnesium metal.

The cathode collector 12b is made of, for example, metal or alloy. More specifically, the cathode collector 12b may be made of a metal selected from, or metals that include at least one selected from, the group consisting of copper, chromium, nickel, titanium, platinum, gold, aluminum, tungsten, iron, and molybdenum or an alloy that contains at least one selected from this group. In an exemplary configuration, the cathode collector 12b may be made of stainless steel.

Alternatively, the cathode collector 12b may be a transparent electrically conductive film. Examples of transparent electrically conductive films include films of indium tin oxide, indium zinc oxide, fluorine-doped tin oxide, antimony-doped tin oxide, indium oxide, and tin oxide.

The cathode collector 12b may be in plate or foil form. The cathode collector 12b may be a multilayer film that is a stack of metal(s) and/or transparent electrically conductive film(s).

If the substrate 11 is electrically conductive and doubles as the cathode collector 12b, the cathode collector 12b may be omitted.

### 6-4. Magnesium-Ion Conductor

The magnesium-ion conductor 10 is, for example, a magnesium-ion conductor as described above and hence is not described here.

### 6-5. Anode

The anode 14 includes, for example, an anode mixture layer 14a, which contains an anode active material, and an anode collector 14b.

The anode mixture layer 14a contains an anode active material capable of occluding and releasing magnesium ions.

In this case, the anode active material can be, for example, a carbon material. Examples of carbon materials include graphite, non-graphitic carbon, such as hard carbon and coke, and graphite intercalation compounds.

The anode mixture layer 14a may contain two or more anode active materials.

If necessary, the anode mixture layer 14a may further contain an electrically conducting material and/or a binder. Examples of electrically conducting materials, binders, solvents, and thickening agents that can optionally be used are the same as described in “6-3. Cathode.”

The thickness of the anode mixture layer 14a is not critical. In an exemplary configuration, it is 1 μm or more and 50 μm or less.

Alternatively, the anode 14 may have, instead of the anode mixture layer 14a, a metallic anode layer on which magnesium metal can be dissolved and deposited. In this case, the layer 14a in FIG. 2 corresponds to the metallic anode layer.

The metallic anode layer in this case is made of metal or alloy. Examples of metals include magnesium, tin, bismuth, and antimony. The alloy is, for example, an alloy of magnesium and at least one selected from aluminum, silicon, gallium, zinc, tin, manganese, bismuth, and antimony.

The anode collector 14b is formed by an electron conductor that is chemically inert toward the anode mixture layer 14a or metallic anode layer within the range of operating voltages of the secondary battery 100. The operating voltage of the anode collector 14b may be in the range of, for example, 0 V to +1.5 V with respect to the standard redox potential of magnesium.

Examples of materials that can be used to make the anode collector 14b are the same as those listed for the cathode collector 12b in “6-3. Cathode.” The anode collector 14b may be in plate or foil form.

If the anode 14 has a metallic anode layer on which magnesium metal can be dissolved and deposited, this metallic layer may double as the anode collector 14b.

### 6-6. Other Considerations

The cathode collector 12b, anode collector 14b, cathode active material layer 12a, and metallic anode layer 14a can be formed by, for example, physical deposition or chemical deposition. Examples of physical deposition techniques include sputtering, vacuum deposition, ion plating, and pulsed laser deposition. Examples of chemical deposition techniques include atomic layer deposition, chemical vapor deposition (CVD), liquid-phase deposition, the sol-gel process, metal organic decomposition, spray pyrolysis, doctor blading, spin coating, and printing techniques. Examples of CVD techniques include plasma-enhanced CVD, thermal CVD, and laser CVD. An example of liquid-phase deposition is wet plating, and examples of wet plating techniques include electroplating, immersion plating, and electroless plating. Examples of printing techniques include inkjet printing and screen printing.

### 7. Experimental Results

### 7-1. First Experiment

### 7-1-1. Preparation of Sample 1

Magnesium-ion conductor sample 1 was prepared as follows.

First, water, PGME, TEOS, EMI-TFSI, and Mg(OTf)₂ were prepared as raw materials. The volumes of water, PGME, and TEOS were 0.5 ml, 1.0 ml, and 0.5 ml, respectively. The molar ratio between TEOS and EMI-TFSI was TEOS:EMI-TFSI=1:1.5. The molar ratio between EMI-TFSI and Mg(OTf)₂ was EMI-TFSI:Mg(OTf)₂=1:0.083.

The raw materials were mixed in a glass vial to give a liquid mixture. The vial was sealed and stored at 25° C. for 11 days. A wet gel formed as a result of the hydrolysis and polycondensation of TEOS.

The wet gel was dried at 40° C. for 96 hours to remove water and PGME. In this way, magnesium-ion conductor sample 1 was obtained.

The molar ratio between silica and EMI-TFSI in sample 1 can be deemed equal or very similar to that between the TEOS and EMI-TFSI used as raw materials. The molar ratio between EMI-TFSI and Mg(OTf)₂ in sample 1 can be deemed equal or very similar to the ratio between these materials at preparation.

### 7-1-2. Preparation of Samples 2 to 13

Magnesium-ion conductor sample 2 was prepared in the same way as sample 1, except that Mg(OTf)₂ was replaced with Mg(ClO₄)₂.

Magnesium-ion conductor sample 3 was prepared in the same way as sample 1, except that Mg(OTf)₂ was replaced with Mg(TFSI)₂.

Magnesium-ion conductor sample 4 was prepared in the same way as sample 1, except that EMI-TFSI was replaced with EMI-BF₄.

Magnesium-ion conductor sample 5 was prepared in the same way as sample 1, except that EMI-TFSI was replaced with EMI-BF₄, and that Mg(OTf)₂ was replaced with Mg(TFSI)₂.

Magnesium-ion conductor sample 6 was prepared in the same way as sample 1, except that EMI-TFSI was replaced with EMI-DCA.

Magnesium-ion conductor sample 7 was prepared in the same way as sample 1, except that EMI-TFSI was replaced with 1-butyl-3-methylimidazolium bis(trifluoromethanesulfonyl)imide (or BMI-TFSI).

Magnesium-ion conductor sample 8 was prepared in the same way as sample 1, except that EMI-TFSI was replaced with BMI-TFSI, and that Mg(OTf)₂ was replaced with Mg(TFSI)₂.

Magnesium-ion conductor sample 9 was prepared in the same way as sample 1, except that EMI-TFSI was replaced with 1-butyl-1-methylpyrrolidinium bis(trifluoromethanesulfonyl)imide (or BMP-TFSI).

Magnesium-ion conductor sample 10 was prepared in the same way as sample 1, except that EMI-TFSI was replaced with BMP-TFSI, and that Mg(OTf)₂ was replaced with Mg(ClO₄)₂.

Magnesium-ion conductor sample 11 was prepared in the same way as sample 1, except that EMI-TFSI was replaced with BMP-TFSI, and that Mg(OTf)₂ was replaced with Mg(TFSI)₂.

Magnesium-ion conductor sample 12 was prepared in the same way as sample 1, except that EMI-TFSI was replaced with 1-methyl-3-propylimidazolium bis(trifluoromethanesulfonyl)imide (or MPI-TFSI).

Magnesium-ion conductor sample 13 was prepared in the same way as sample 1, except that EMI-TFSI was replaced with 1-methyl-1-propylpiperidinium bis(trifluoromethanesulfonyl)imide (or MPPyr-TFSI).

### 7-1-3. Measurement of Ionic Conductivity

The ionic conductivity of samples 1 to 13 was determined by alternating current (AC) impedance measurement. The measurement was carried out using an electrochemical measurement system (Bio-Logic Science Instruments VMP-300) at AC voltages between 50 and 100 mV and over the frequency range of 0.01 Hz to 1 MHz under the conditions of 0.0005% relative humidity and temperatures between 22° C. and 23° C.

Table 1 summarizes the composition and molecular weight of the ionic liquid, the composition of the magnesium salt, and ionic conductivity (mS/cm) for each sample.

TABLE 1

| | Ionic liquid | | | Ionic |
|---|---|---|---|---|
| | | Molecular | Magnesium | conductivity |
| | Composition | weight | salt | (mS/cm) |
| Sample 1 | EMI-TFSI | 393 | Mg(OTf)₂ | 7.2 |
| Sample 2 | EMI-TFSI | 393 | Mg(ClO₄)₂ | 4.6 |
| Sample 3 | EMI-TFSI | 393 | Mg(TFSI)₂ | 4.4 |
| Sample 4 | EMI-BF₄ | 197 | Mg(OTf)₂ | 10.0 |
| Sample 5 | EMI-BF₄ | 197 | Mg(TFSI)₂ | 6.0 |
| Sample 6 | EMI-DCA | 224 | Mg(OTf)₂ | 10.8 |
| Sample 7 | BMI-TFSI | 419 | Mg(OTf)₂ | 2.4 |
| Sample 8 | BMI-TFSI | 419 | Mg(TFSI)₂ | 3.1 |
| Sample 9 | BMP-TFSI | 422 | Mg(OTf)₂ | 1.8 |
| Sample 10 | BMP-TFSI | 422 | Mg(ClO₄)₂ | 1.3 |
| Sample 11 | BMP-TFSI | 422 | Mg(TFSI)₂ | 0.9 |
| Sample 12 | MPI-TFSI | 405 | Mg(OTf)₂ | 3.5 |
| Sample 13 | MPPyr-TFSI | 408 | Mg(OTf)₂ | 2.2 |

As shown in Table 1, samples 1 to 6, in which the cation in the ionic liquid was EMI⁺, exhibited high ionic conductivity in comparison with samples 7 to 13. Specifically, for all of samples 1 to 6, the ionic conductivity was higher than 4.0 mS/cm. These values are higher than, for example, the ionic conductivity of commercially available magnesium electrolyte Maglution™ B02 (FUJIFILM Wako Pure Chemical), 3.8 mS/cm. The data from samples 1 to 13 indicate that ionic conductivity can improve whatever the anion in the ionic liquid and the magnesium salt.

When samples 1, 4, and 6 were compared, the ionic conductivity of samples 4 and 6, in which the anions in the ionic liquid were BF₄⁻ and DCA⁻, respectively, was higher than that of sample 1, in which the anion in the ionic liquid was TFSI⁻. A similar trend was also observed in the comparison between samples 3 and 5. This difference, presumably, owes to the smallness in size of BF₄⁻ and DCA⁻ compared with TFSI⁻.

When samples 1, 2, and 3 were compared, the ionic conductivity of sample 1, in which the magnesium salt was Mg(OTf)₂, was higher than that of samples 2 and 3, in which the magnesium salts were Mg(ClO₄)₂ and Mg(TFSI)₂, respectively. A similar trend was also observed in the comparison between samples 4 and 5. This difference, presumably, owes to the resonance structure of OTf⁻ as a component of Mg(OTf)₂. The OTf⁻ ion has negative charge delocalized on its three oxygen atoms and one sulfur atom and therefore is weak in constraining the magnesium ion.

From another angle, the data in Table 1 can be understood as showing that samples 1 to 6 exhibited high ionic conductivity by virtue of the molecular weight of the ionic liquid being smaller than 400, and samples 4 to 6, in which the molecular weight of the ionic liquid was smaller than 250, were particularly high in ionic conductivity.

### 7-2. Second Experiment

### 7-2-1. Preparation of Samples 14 to 22

Magnesium-ion conductor sample 14 was prepared in the same way as sample 1, except that EMI-TFSI:Mg(OTf)₂=1:0.021.

Magnesium-ion conductor sample 15 was prepared in the same way as sample 1, except that EMI-TFSI:Mg(OTf)₂=1:0.042.

Magnesium-ion conductor sample 16 was prepared in the same way as sample 1, except that EMI-TFSI:Mg(OTf)₂=1:0.167.

Magnesium-ion conductor sample 17 was prepared in the same way as sample 1, except that EMI-TFSI:Mg(OTf)₂=1:0.333.

Magnesium-ion conductor sample 18 was prepared in the same way as sample 1, except that TEOS:EMI-TFSI=1:1.0.

Magnesium-ion conductor sample 19 was prepared in the same way as sample 1, except that TEOS:EMI-TFSI=1:1.0, and that EMI-TFSI:Mg(OTf)₂=1:0.042.

Magnesium-ion conductor sample 20 was prepared in the same way as sample 1, except that TEOS:EMI-TFSI=1:1.0, and that EMI-TFSI:Mg(OTf)₂=1:0.083.

Magnesium-ion conductor sample 21 was prepared in the same way as sample 1, except that TEOS:EMI-TFSI=1:1.0, and that EMI-TFSI:Mg(OTf)₂=1:0.167.

Magnesium-ion conductor sample 22 was prepared in the same way as sample 1, except that TEOS:EMI-TFSI=1:1.0, and that EMI-TFSI:Mg(OTf)₂=1:0.333.

### 7-2-2. Measurement of Ionic Conductivity

The ionic conductivity of samples 1 and 14 to 22 was measured as in “7-1-3. Measurement of Ionic Conductivity.” The transport number of magnesium ions in samples 1 and 14 to 22 was also determined, in the way as described in Bruce PG, Vincent CA, Steady state current flow in solid binary electrolyte cells, J. Electroanal. Chem. 225 (1987) 1-17. The measured ionic conductivity was multiplied by the transport number of magnesium ions to give magnesium ion conductivity.

Table 2 summarizes the molar ratio of Mg(OTf)₂ to EMI-TFSI, the molar ratio of EMI-TFSI to TEOS, the ionic conductivity (mS/cm) of all free ions (total ionic conductivity), the transport number of magnesium ions, and the magnesium ion conductivity (mS/cm) for each sample. It should be noted that for each sample, the molar ratio of EMI-TFSI to porous silica can be deemed equal or very similar to that of EMI-TFSI to TEOS.

TABLE 2

| | Mg(OTF)₂/ | EMI-TFSI/ | Total ionic | Mg ion | Mg ion |
|---|---|---|---|---|---|
| | EMI-TFSI | TEOS | conductivity | transport | conductivity |
| | (molar ratio) | (molar ratio) | (mS/cm) | number | (mS/cm) |
| Sample 14 | 0.021 | 1.5 | 5.89 | 0.03 | 0.19 |
| Sample 15 | 0.042 | 1.5 | 6.70 | 0.28 | 1.87 |
| Sample 1 | 0.083 | 1.5 | 7.15 | 0.32 | 2.31 |
| Sample 16 | 0.167 | 1.5 | 3.80 | 0.42 | 1.58 |
| Sample 17 | 0.333 | 1.5 | 2.48 | 0.30 | 0.75 |
| Sample 18 | 0.021 | 1.0 | 4.77 | 0.03 | 0.14 |
| Sample 19 | 0.042 | 1.0 | 4.63 | 0.25 | 1.16 |
| Sample 20 | 0.083 | 1.0 | 4.31 | 0.30 | 1.29 |
| Sample 21 | 0.167 | 1.0 | 2.96 | 0.40 | 1.18 |
| Sample 22 | 0.333 | 1.0 | 1.56 | 0.35 | 0.55 |

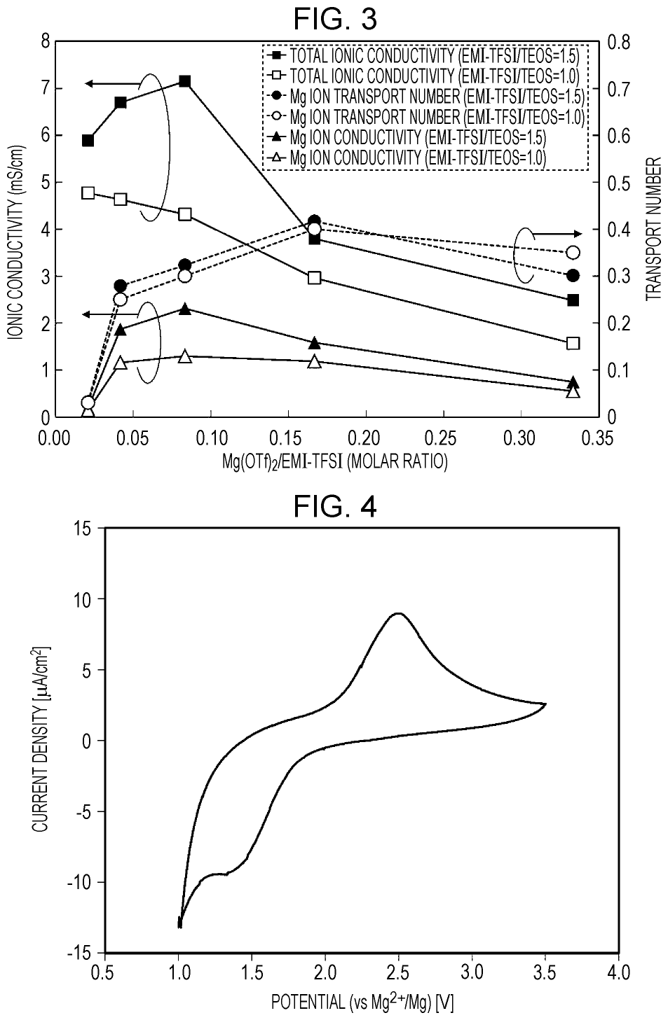

FIG. 3 is a graphical representation of the data in Table 2. The solid squares (▪), circles (●), and triangles (▴) represent the total ionic conductivity, the transport number of magnesium ions, and magnesium ion conductivity, respectively, for the samples in which the molar ratio of EMI-TFSI to TEOS was 1.5, i.e., samples 1 and 14 to 17. The open squares (□), circles (◯), and triangles (Δ) represent the total ionic conductivity, the transport number of magnesium ions, and magnesium ion conductivity, respectively, for the samples in which the molar ratio of EMI-TFSI to TEOS was 1.0, i.e., samples 18 to 22.

The following trends were observed in FIG. 3. The total ionic conductivity generally decreased with increasing molar ratio of Mg(OTf)₂ to EMI-TFSI, presumably because magnesium ions became more constrained in the electrolyte with increasing relative abundance of divalent Mg²⁺ and decreasing relative abundance of monovalent EMI⁺. The transport number of magnesium ions, by contrast, increased with increasing molar ratio of Mg(OTf)₂ to EMI-TFSI, or in other words with increasing concentration of magnesium ions in the electrolyte, followed by a slight decrease after the Mg(OTf)₂ to EMI-TFSI molar ratio exceeded 0.167. As a consequence of these trends, the magnesium ion conductivity was relatively high when the Mg(OTf)₂ to EMI-TFSI molar ratio was 0.042, 0.083, or 0.167.

When the molar ratio of EMI-TFSI to TEOS was 1.5, furthermore, the total ionic conductivity increased when the Mg(OTf)₂ to EMI-TFSI molar ratio was in the range of 0.021 to 0.083. Accordingly, the magnesium ion conductivity was high when the Mg(OTf)₂ to EMI-TFSI molar ratio was 0.042 or 0.083.

### 7-3. Third Experiment

### 7-3-1. Fabrication of a Battery Cell

A battery cell was fabricated as follows using magnesium-ion conductor sample 15 as its solid electrolyte. The fabrication process was carried out in a glove box with a relative humidity of 0.0005% or less.

First, the cathode was prepared by forming a 200-nm thick film of vanadium pentoxide (V₂O₅), by sputtering, on stainless steel foil (SUS316) as a cathode collector.

Then, as the anode, a 0.1-mm thick magnesium plate was prepared.

As the solid electrolyte, roughly 0.05 g of magnesium-ion conductor sample 15 was sandwiched between the cathode and anode and compressed with a pressure of 500 N/cm² to a thickness of approximately 300 μm. The resulting stack of the cathode, solid electrolyte, and anode was shaped using a polypropylene cylinder with an inner diameter of 10 mm. The solid electrolyte was in contact with each of the cathode and anode in an area of 78.5 mm². In this way, a battery cell was fabricated.

### 7-3-2. Cyclic Voltammetry

The fabricated battery cell was analyzed by cyclic voltammetry (CV).

Using the aforementioned electrochemical measurement system, the analysis was carried out over the voltage range of 1.0 to 3.2 V (vs. Mg²⁺/Mg) and at a scan rate of 0.1 mV/s.

FIG. 4 illustrates the cyclic voltammogram of the battery cell. As shown in FIG. 4, the CV peaked near 1.4 V reflecting the cathodic reaction and near 2.5 V reflecting the anodic reaction. The former appears to correspond to the insertion of magnesium ions from the magnesium-ion conductor into the cathode (i.e., V₂O₅), and the latter to the separation of magnesium metal on the surface of the anode out of the magnesium-ion conductor. After discharge, the surface of the V₂O₅ film had been discolored as a result of a change in density.

### 7-3-3. Measurement of the X-Ray Absorption Near-Edge Structure

For the fabricated battery cell, the electronic state of vanadium in the V₂O₅ film was examined by X-ray absorption near-edge structure (XANES) analysis. The analysis was carried out before and after discharge at a rate of 0.1 C using beamline BL16XU at SPring-8.

First, V₂O₅ (pentavalent V), V₂O₄ (tetravalent V), and V₂O₃ (trivalent V) (powders; Sigma-Aldrich) were prepared as reference standards. These reference standards were measured in the fluorescence mode to clarify the relationship between the valency of vanadium and a shift of the vanadium K-edge pre-edge peak. Then the V₂O₅ film of the battery cell was subjected to the same measurement before and after discharge. The position and intensity of the pre-edge peak in the spectra from the V₂O₅ film were compared with those in the spectra from the reference standards to determine the valency of vanadium in the V₂O₅ film before and that after discharge.

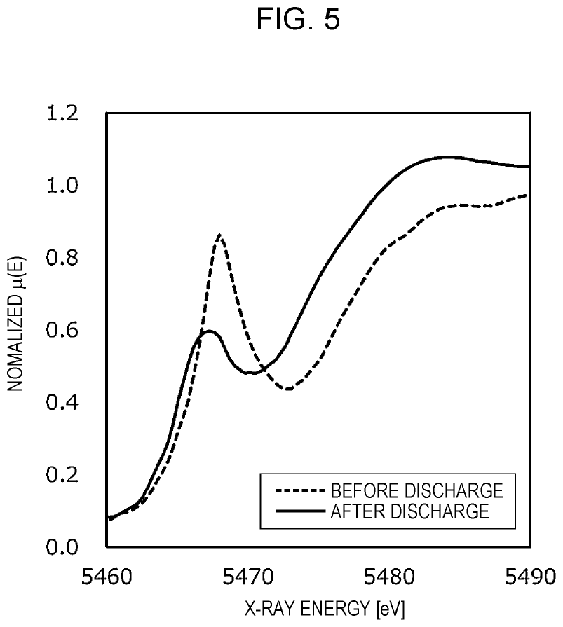

FIG. 5 illustrates the vanadium K-edge XANES spectra before and after discharge of the battery cell. As shown in FIG. 5, the V₂O₅ film exhibited a pre-edge peak corresponding to the 1 s to 3 d transition near 5468 eV before discharge and near 5467 eV after discharge. That is, the pre-edge peak shifted and its intensity changed before and after discharge.

The valency of vanadium in the V₂O₅ film before discharge and that after discharge were determined using the reference standards. The valency of vanadium was 4.5 before discharge and 3.0 after discharge, indicating that during the discharging operation, magnesium ions were inserted from the magnesium-ion conductor into V₂O₅, and, as a consequence, the valency of vanadium decreased.

### 7-4. Other Considerations

For comparison purposes, magnesium-ion conductor sample 23 was prepared as a conductor that contained no porous silica, or was exclusively electrolyte. Specifically, EMI-TFSI and Mg(OTf)₂ were prepared as raw materials. The molar ratio between EMI-TFSI and Mg(OTf)₂ was EMI-TFSI:Mg(OTf)₂=1:0.083. The raw materials were mixed in a glass vial to give a liquid mixture. In the liquid mixture, however, Mg(OTf)₂ did not dissolve completely; part of it remained undissolved even after heating and stirring.

In the preparation of sample 1, by contrast, Mg(OTf)₂ completely dissolved after various raw materials were mixed. When the resulting liquid mixture was stored, a wet gel formed with a uniform electrolyte contained therein. This difference between samples 1 and 23 indicates that the products of the hydrolysis of TEOS and silica formed by the polymerization of TEOS help Mg(OTf)₂ dissolve in EMI-TFSI. Presumably, anions in Mg(OTf)₂ were attracted to silanol groups existing on the surface of the hydrolysates of TEOS or silica, and this facilitated the release of Mg ions.

Overall, it was demonstrated that discharge reaction occurred in a battery cell fabricated using magnesium-ion conductor sample 15 as its solid electrolyte.

What is claimed is:

1. A solid-like magnesium-ion conductor comprising:
an electrolyte including at least one magnesium salt, and an ionic liquid containing 1-ethyl-3-methylimidazolium ion; and
a porous silica having a plurality of pores, in which the electrolyte is filled.

2. The solid-like magnesium-ion conductor according to claim 1, wherein
the ionic liquid has a molecular weight of 400 or less.

3. The solid-like magnesium-ion conductor according to claim 1, wherein
the ionic liquid further contains at least one selected from the group consisting of dicyanamide ion, tetrafluoroborate ion, and bis(trifluoromethanesulfonyl)imide ion.

4. The solid-like magnesium-ion conductor according to claim 1, wherein
a molar ratio of the magnesium salt to the ionic liquid is more than 0.04 and less than 0.10.

5. The solid-like magnesium-ion conductor according to claim 1, wherein
the magnesium salt includes at least one selected from the group consisting of magnesium trifluoromethanesulfonate, magnesium bis(trifluoromethanesulfonyl)imide, and magnesium perchlorate.

6. The solid-like magnesium-ion conductor according to claim 1, wherein:
the porous silica has a structure in which a plurality of silica particles are joined together; and
the silica particles have an average diameter of 2 nm or more and 10 nm or less.

7. The solid-like magnesium-ion conductor according to claim 1, wherein
the ionic liquid is present in a greater number of moles than the porous silica.

8. The solid-like magnesium-ion conductor according to claim 1, wherein
the ionic liquid contains an anion having a size L, in Å, that satisfies 4×n≤L≤5×n or 5/n≤L≤4/n, where n is a positive integer.

9. The solid-like magnesium-ion conductor according to claim 1, wherein
the ionic liquid contains at least one selected from the group consisting of dicyanamide ion and tetrafluoroborate ion.

10. A secondary battery comprising:
a cathode;
an anode; and
the solid-like magnesium-ion conductor according to claim 1.
